(19) United States
(12) Patent Application Publication
(10) Pub. No.: US 2012/0217436 A1
(43) Pub. Date: Aug. 30, 2012

(54) BORON SUBOXIDE COMPOSITE MATERIAL

(76) Inventors: Axel Bales, London (GB); Jan Raethel, London (GB); Maik Thiele, London (GB); Mathias Herrmann, London (GB)

(21) Appl. No.: 13/383,254

(22) PCT Filed: Jul. 21, 2010
(86) PCT No.: PCT/IB2010/053324

§ 371 Date: May 10, 2012

(30) Foreign Application Priority Data
Jul. 22, 2009 (GB) 0912736.6

(51) Int. Cl. C09K 3/00

(52) U.S. Cl. 252/182.33

(57) ABSTRACT

The invention provides a boron suboxide composite material comprising boron suboxide and a secondary phase, wherein the secondary phase contains a metal selected from the group of gold, silver and copper and alloys based on or containing one or more of these metals. Moreover, the metal or alloy is present in the material in an amount of less than about 20 volume %, and preferably less than about 6 volume %.

### BACKGROUND OF THE INVENTION

The invention relates to a boron suboxide composite material.

The development of synthetic ultrahard materials which have hardness values approaching or even exceeding that of diamond has been of great interest to material scientists. With a Vickers hardness of between 70 to 100 GPa, diamond is the hardest material known, followed by cubic boron nitride (Hᵥ˜60 GPa) and boron suboxide, herein also referred to as B₆O. Hardness values of 53 GPa and 45 GPa have been determined at 0.49 N and 0.98 N load respectively for B₆O single crystals, which are similar to those of cubic boron nitride.

It is known that B₆O may also be non-stoichiometric i.e. exist as B₆O₁₋ₓ (where x is in the range 0 to 0.3). Such non-stoichiometric forms are included in the term B₆O. The strong covalent bonds and short interatomic bond length of these materials contribute to their exceptional physical and chemical properties such as great hardness, low mass density, high thermal conductivity, high chemical inertness and excellent wear resistance. Potential industrial applications include use in grinding wheels, abrasives and cutting tools.

Several techniques have been employed for producing boron suboxide and include such procedures as reacting elemental boron (B) with boron oxide (B₂O₃) under suitably high pressure and high temperature conditions. In U.S. Pat. No. 3,660,031 other methods of producing boron suboxides such as reducing boron oxide (B₂O₃) with magnesium, or by reducing zinc oxide with elemental boron are mentioned. With each of these known procedures however, there are drawbacks which retard the usefulness of the material in industry. For example, the reduction of B₂O₃ with magnesium produces a solid solution of magnesium and magnesium boride contaminants in the suboxide, while the reduction of magnesium oxide with boron produces only a relatively small yield of boron suboxide and is very inefficient.

WO2007/029102 discloses B₆O composites made with aluminium compounds which resulted in an aluminium borate phase at the grain boundary. A fracture toughness of about 3.5 MPa·m^{0.5} with a corresponding hardness of 29.3 GPa was obtained. The aluminium phases present in the composite are soft and although they may improve the fracture toughness of the resulting composite, they do not contribute to the overall hardness of the composite.

WO 2008/132676 describes a boron suboxide composite material comprising boron suboxide and a secondary phase, the secondary phase containing a boride such as zirconium boride, hafnium boride, tungsten boride, molybdenum boride and the like.

WO 2008/132674 describes a boron suboxide composite material comprising boron suboxide and a secondary phase, the secondary phase containing a mixture of at least two metal oxides, neither of which is a boron containing oxide.

WO 2008/132672 describes a boron suboxide composite material comprising boron suboxide and a secondary phase, the secondary phase containing a rare earth metal oxide.

U.S. Pat. No. 5,456,735 discloses a method of removing material from a surface by abrading the surface with an abrasive tool comprising a boron suboxide composite material. The boron suboxide composite material comprises boron suboxide particles in a matrix which, in one embodiment, may be a copper based alloy. The copper based alloy is present in an amount of at least 25 volume percent.

There is a need for boron suboxide material (B₆O) having enhanced mechanical properties, particularly enhanced fracture toughness.

### SUMMARY OF THE INVENTION

According to the present invention, there is provided a boron suboxide composite material comprising boron suboxide and a secondary phase, wherein the secondary phase contains a metal selected from the group of gold, silver and copper and alloys based on or containing one or more of these metals and wherein the metal or alloy is present in the material in an amount of less than about 20 volume %, preferably less than about 6 volume %.

The presence of the metal in the secondary phase may make the composite material more readily brazeable to a substrate.

Brazing may be achieved using any suitable brazing alloy known in the art. An example of a suitable brazing alloy is a Cu/Ag/Ti alloy.

The secondary phase may consist essentially of the metal, i.e. any other elements or compounds will be in trace or minor amounts only.

The secondary phase may contain other elements or compounds which improve or enhance the properties of the composite material. In some embodiments, a boride former such as titanium, vanadium, nickel, iron, cobalt or chromium may be present in the secondary phase. All of these elements are strong boride formers resulting in borides being formed during manufacture of the composite material. While not wishing to be bound by a particular theory, the formation of borides improves the wettability and bonding of the metal to the B₆O phase, which may result in the formation of stronger ductile bridges in the composite material. When the other element or compound is a boride former or boride, such element or compound may be present in the secondary phase in an amount of less than 50 weight %.

The boron suboxide may be particulate or granular boron suboxide. The mean grain size of the boron suboxide particles or granules themselves is preferably fine and may range from 100 nm to 100 μm, preferably 100 nm to 10 μm.

Finely particulate boron suboxide may be produced, for example, by subjecting a source of boron suboxide to milling. If milling takes place in the presence of an iron or cobalt containing milling medium, some iron and/or cobalt may be introduced into the material which is sintered. For an iron-free material, the milled powder can be washed with hydrochloric acid, or the milling can be carried out with alumina pots and milling balls. It has been found to be advantageous to wash the milled powder in warm water or alcohols to remove any excess of B₂O₃ or H₃BO₃.

The composite material of the invention comprises boron suboxide, generally in particulate or granular form, and the secondary phase in a bonded, coherent form. The secondary phase may be uniformly dispersed among the boron suboxide.

The composite material of the invention may be made by providing a source of boron suboxide particles or granules; contacting the source of boron suboxide with the metal or a compound which, under the sintering conditions, produces the metal to create a reaction mass; and sintering the reaction mass to produce the boron suboxide composite material.

In some embodiments of the invention, the metal or alloy may be present in the reaction mass in metallic form, and in some embodiments, the metal may be present in the form of a salt or oxide which is converted to the metal during sintering. The metal or alloy in metallic form, salt or oxide may be mixed with the boron suboxide or may be provided as a coating on the boron suboxide.

The metal or alloy in the reaction mass may contain some boron. The boron is soluble in the molten metal and also has the effect of reducing interaction of the metal with the boron suboxide.

Sintering preferably takes place at a pressure of less than 200 MPa and a temperature not exceeding 1950° C. Low pressure sintering processes such as hot pressing (HP), gas pressure sintering, hot isostatic pressing (HIP) or spark plasma sintering (SPS) are preferred. The SPS process is characterised by very fast heating and short isothermal holding times, in particular with heating rates of 50-400 K/minute and isothermal holding times of 5 minutes or less. The hot pressing process is characterised by heating rates of 10-20 K/minute, and isothermal holding times of about 15 to 25, typically 20, minutes.

The boron suboxide may be mixed with the components necessary to produce the secondary phase prior to the sintering step. The boron suboxide may alternatively be coated with the secondary phase components prior to sintering.

In one form of the invention, a porous sintered boron suboxide material is infiltrated with the metal or alloy. The porous, sintered boron suboxide material may be produced, for example, by compacting boron suboxide particles or granules or by sintering boron and B₂O₃ at elevated temperature, e.g. 1350° C., in an inert gas such as argon. When the boron suboxide material is to contain a boride, a mixture of titanium dioxide and boron can be sintered producing boron suboxide and a secondary phase of titanium boride.

The composite material according to the invention may be used in cutting applications and in wear parts. The presence of the metal in the secondary phase renders the composite material readily brazeable to substrates such as cemented carbide substrates. The composite material may also be crushed to grit form and used in grit applications. Moreover, the composite material may be used in armour applications, such as ballistic armour, and particularly body armour.

### DESCRIPTION OF EMBODIMENTS OF THE INVENTION

The invention will now be illustrated by the following example.

### Example

B₆O starting powder with a mean grain size of d50=2.23 μm was admixed with 2 wt % Ag₂O using an attritor mill with alumina balls, in an ethanol solvent for 6 hours. The wear of the alumina balls was 0.8 wt %.

The milled mixture was dried using a rotary evaporator, after which fast spark plasma sintering was carried out using graphite dies with graphite foils. The graphite foils were coated with a BN suspension to prevent interaction with the graphite. The milled mixture was sintered using the SPS method with a heating rate of 50 K/min, a temperature of 1900° C., and a pressure of 50 MPa, under an argon atmosphere for 5 minutes.

Since a nonconductive hBN lining or coating was used, the densification was more a fast hot pressing than a SPS-process, which is characterized by a current going through the powder.

A fully densified composite material was produced comprising boron suboxide particles within which a secondary phase was uniformly dispersed. A cross-section of the sample was polished and then tested for hardness and fracture toughness with a Vickers indenter. The hardness was found to be about 37±0.7 GPa at a load of 0.4 kg and a fracture toughness of about 4.6 MPa·m^{0.5}.

The XRD analysis showed that the Ag₂O was converted into metallic silver.

The Al₂O₃ (wear of the milling balls) result in some additional grain boundary phase: Al₂₀B₄O₃₆.

Milling the B6O powder with steel balls and then precipitating the silver from AgNO3 solution produced a dense sample, without Al impurities, under the same conditions set out above. The sample showed similar characteristics to composite material described above.

1. A boron suboxide composite material comprising boron suboxide and a secondary phase, wherein the secondary phase contains a metal selected from gold, silver and copper and alloys based on or containing one or more of these metals and wherein the metal or alloy is present in the material in an amount of less than 20 volume %.

2. A boron suboxide composite material according to claim 1 wherein the secondary phase consists essentially of the metal or alloy.

3. A boron suboxide composite material according to claim 1 wherein the secondary phase contains another element or compound.

4. A boron suboxide composite material according to claim 3 wherein the other element or compound is a boride former or boride thereof.

5. A boron suboxide composite material according to claim 4 wherein the boride former is selected from titanium, vanadium, nickel, iron, cobalt and chromium.

6. A boron suboxide composite material according to claim 1 wherein the metal or alloy is present in the material in amount of less than 6 volume %.

7. (canceled)
